(19) United States
(12) Patent Application Publication
(10) Pub. No.: US 2015/0117493 A1
(43) Pub. Date: Apr. 30, 2015

(54) Phosphor Thermometry Fiber Sensor

(71) Applicant: United Technologies Corporation, Hartford, CT (US)

(72) Inventor: Bruce Hockaday, Vernon, CT (US)

(21) Appl. No.: 14/338,520

(22) Filed: Jul. 23, 2014

Related U.S. Application Data
(60) Provisional application No. 61/895,638, filed on Oct. 25, 2013.

(51) Int. Cl. G01K 11/32; F01D 21/00

(52) U.S. Cl. CPC G01K 11/3213; F01D 21/003
USPC 374/161

(57) ABSTRACT

High precision phosphor temperature sensors are disclosed. The sensors include a light source that emits an excitation light through one or more optical fibers to one or more phosphors that produce fluorescent emission(s) when engaged by the excitation light. The fluorescent emission(s) is transmitted optically from the phosphor(s) directly to a detector or an optical diffraction grating before the light is received at a detector. The detector is linked to a controller, which measures the lifetime(s) of the fluorescent emission(s) and calculates the temperature at the phosphor(s) from said lifetime(s).

### CROSS-REFERENCE TO RELATED APPLICATION

This is a Non-Provisional Patent Application claiming priority under 35 U.S.C. §119(e) to U.S. Provisional Patent Application No. 61/895,638 filed on Oct. 25, 2013.

### TECHNICAL FIELD

This disclosure relates to a phosphor based temperature sensors and temperature sensing methods. More specifically, this disclosure relates to a phosphor based temperature sensor and a temperature measuring method for measuring temperature in accordance with the optical emission decay time of fluorescent light emitted by a phosphor after it has been excited with a light source.

### BACKGROUND

A phosphor is a substance that exhibits the phenomenon of luminescence. Phosphors include both phosphorescent materials, which show a slow decay in brightness (>1 ms), and fluorescent materials, where the emission decay takes place over tens of nanoseconds. This disclosure is concerned with fluorescent materials that decay slowly and quickly and that are common in sensors, such as temperature sensors.

In a phosphor based temperature sensor, temperature is measured using a phosphor wherein the fluorescent characteristics of the phosphor vary depending on the temperature. Specifically, the phosphor is exposed to an excitation light from a light source, such as a UV light source, and the fluorescent light produced by the phosphor is detected. The temperature is measured through the change in the characteristics of the fluorescent light, such as the fluorescent emission “lifetime” or decay constant.

The phosphor may be disposed at an end of a tube or optical fiber. When the excitation light is radiated from the light source, it is illuminated onto the phosphor through the tube. The fluorescent light that is produced by the phosphor is detected by a detector. The fluorescent intensity (I) decays in accordance with equation I=Iₒe^{-t/τ}, where t represents time, Iₒ is the initial intensity at t=0, e represents the base of the natural logarithm (2.718 . . . ) and τ is the lifetime of the fluorescence. The lifetime τ is the slope of the natural log of the time dependent emission and is therefore a critical parameter used in determining temperature.

Thin coatings of phosphors, less than 50 micrometers thick, on components such as turbine rotors vanes and the like, have been activated by pulsed and steady state light sources to produce fluorescence signals that are analyzed to yield temperature. The temperature dependence of the lifetime τ of the fluorescence results from the competition for allowed de-excitation processes that take place within excited dopant (activator) ions. At increasing temperatures, larger numbers of non-radiative (non-photon-emitting) transitions are allowed, thereby shortening the lifetime of photon emitting de-excitations through depopulation of the ionic excited states. Therefore, as the temperature increases, the characteristic fluorescence of these materials decreases in lifetime τ and intensity I. As a result, the measurement of the lifetime τ of the fluorescent emission from the excited phosphor is a measure of the temperature of the phosphor.

The emission of a phosphor may comprise several discreet narrow wavelength bands or spectral lines. These spectral lines change in relative amplitude with respect to each other as a function of temperature. Some phosphors emit families of spectral lines where one line is dominant over a range of temperature. As the temperature moves beyond this range, another spectral line may dominate the emission of the excitation energy. An overlap region may occur between two ranges where both dominant spectral lines are present and the relative amplitude of each line changes as a function of temperature.

An optical band-pass filter is an optical component that permits light of a certain frequency range to pass through the filter, while rejecting or attenuating frequencies that fall outside of the range. In contrast, a diffraction grating is another optical component having a periodic structure, which splits and diffracts light into several beams travelling in different directions. The directions of these beams depend on the spacing of the grating and the wavelength of the light so that the grating acts as a dispersive element. Because of this dispersive property, gratings are commonly used in spectrometers.

A complex engine like a gas turbine engine needs to be thoroughly instrumented in order to validate safe and correct operation. To operate such an engine efficiently, the temperatures at various places or “stations” within the engine need to be known. FIG. 1 is a sectional view of a gas turbine engine 10. The gas turbine engine 10 may include a fan assembly 11 that is mounted immediately aft of a nose cone 12 and immediately fore of a low pressure compressor (LPC) 13. A gear box (not shown) may be disposed between the fan blade assembly and the LPC 13. The LPC 13 may be disposed between the fan blade assembly 11 and a high pressure compressor (HPC) 14. The LPC 13 and HPC 14 are disposed fore of a combustor 15, which may be disposed between the HPC 14 and a high pressure turbine (HPT) 16. The HPT 16 is typically disposed between the combustor 15 and a low pressure turbine (LPT) 17. The LPT 17 may be disposed immediately fore of a nozzle 18. The LPC 13 may be coupled to the LPT 17 via a shaft 21, which may extend through an annular shaft 22 that may couple the HPC 14 to the HPT 16. An engine case 23 may be disposed within an outer nacelle 24. An annular bypass flow path may be created by the engine case 23 and the nacelle 24 that permits bypass airflow or airflow that does not pass through the engine case 23 but, instead, flows from the fan assembly 11, past the fan exit guide vane 26 and through the bypass flow path 25. One or more frame structures 27 may be used to support the nozzle 18.

The main reasons to continuously monitor gas turbine engine temperatures include: the ability to calculate the efficiency of compressors and turbines; the control of the engine power through all the different operating conditions where temperature monitoring at the different stations plays a major role; monitoring of high temperature components and temperature limits; and maintenance of a temperature history of the components to estimate their residual life.

Temperature measurements from thermocouples immersed in flowing gases include systematic errors, primarily caused by heat transfer and variability of wire lots in thermoelectric signal generation capability, i.e., calibration. In particular, heat transfer occurs through conduction along the wires and the sheath of the thermocouple; through radiation to/from the walls and the blades/vanes surfaces; and through convection at the boundary layer around the thermocouple. Conduction and radiation give rise to two measurement errors called conduction error and radiation error respectively or systematic errors collectively. Thermocouple wire sensitivities may vary from lot-to-lot as shown in the tolerance range of commercially available sensing wire.

Thus, there is a need for improved temperature sensor devices for high temperature, high gas flow velocity applications such as those encountered in gas turbine engines without resorting to thermocouples and their inherent disadvantages.

### SUMMARY

In one aspect, a temperature sensor is disclosed. The disclosed temperature sensor may include a light source that is optically coupled to at least one phosphor. The light source emits an excitation light onto the one or more phosphors and the one or more phosphors each produce a fluorescent emission when exposed to the excitation light. The phosphor may be optically coupled to a detector and the detector may be linked to a controller. The controller may have a memory programmed to calculate temperature from a lifetime of the fluorescent emission.

In another aspect, a gas turbine engine is disclosed. The disclosed gas turbine engine includes at least one temperature sensor. The at least one temperature sensor includes a light source that is optically coupled to at least one phosphor. The light source emits an excitation light onto the phosphor(s) which results in the phosphor(s) producing a fluorescent emission(s) when exposed to the excitation light. The phosphor(s) may be optically coupled to at least one filter. The filter may be optically coupled to a detector. The detector may be linked to a controller. The controller may also be linked to the light source. The controller may also have a memory programmed to calculate temperature from a lifetime of the fluorescent emission.

In yet another aspect, a gas turbine engine is disclosed that includes at least one temperature sensor. The temperature sensor may include a light source optically coupled to at least one phosphor and an optical diffraction grating. The optical diffraction grating may be optically coupled to a plurality of detectors. Each of the plurality of detectors may be linked to a controller. The controller may be linked to the light source. The controller may also have a memory programmed to calculate temperature from a lifetime of the fluorescent emission(s).

In any one or more of the embodiments described above, the light source may be optically coupled to a first optical fiber. The first optical fiber may be connected to a second optical fiber and a third optical fiber at a coupler, such as a Y-coupler or a 1×2 coupler. Other types of couplers, such as 1×3, 1×4, 1×8, . . . 1×N couplers are available, as will be apparent to those skilled in the art. The second optical fiber may connect the coupler to a detector and the third optical fiber may connect the coupler to a sensing end of the third optical fiber that is coated with the phosphor(s). The third optical fiber may transmit the fluorescent emission(s) from the phosphor(s) to the coupler which transmits at least some of the fluorescent emission(s) through the second optical fiber to the detector.

In any one or more of the embodiments described above, more than one phosphor can be coated onto the optical fiber. In other words, more than one phosphor can be mixed and deposited onto the sensing surface to extend the usable temperature range of the sensor.

In any one or more of the embodiments described above, the sensing end of the third optical fiber and the phosphor(s) may be coated with an opaque material.

In any one or more of the embodiments described above, the light source may be an ultra-violet light source. In a further refinement of this concept, the ultra-violet light source may be solid state. However, this disclosure is not limited to the use of ultra-violet light at the light source. Because more than one phosphor may be employed, fluorescent emissions may be generated by light sources of different wave lengths. This is particularly true because one employed phosphor may have a decay time or life time that is measured in nano seconds and another employed phosphor may have a decay time or life time measured in milliseconds.

In any one or more of the embodiments described above, the detector may be a photo detector.

In any one or more of the embodiments described above, the detector may be linked to a controller having a memory programmed to calculate temperature from a lifetime of the fluorescent emission.

In any one or more of the embodiments described above, the phosphor may be selected from, but not limited to, the group consisting of YVO₄:Dy; Y₂O₃:Dy; Mg₄FGeO₆:Mn; YVO₄:Eu; Y₂O₃:Eu; YAG:Tb; YAG:DY; YAG:Eu; LuPO₄:Dy and combinations thereof.

In any one or more of the embodiments described above, when a coupler is employed, the branch splitting ratio may be adjusted as a function of optical wavelength allowing substantially larger fraction of the emission to travel to the detector(s) instead of traveling to the light source.

In any one or more of the embodiments described above, a filter may be optically coupled between the detector(s) and the phosphor(s). In a further refinement of this concept, a filter may be optically coupled between the detector(s) and the coupler(s). In still a further refinement of this concept, a filter may be optically coupled to the second optical fiber between the detector(s) and the coupler.

In any one or more of the embodiments described above, an optical diffraction grating may be optically coupled between the detector(s) and the phosphor(s). In such a refinement, the detector may be a detector(s) array, such as a linear detector array.

In any one or more of the embodiments described above, the optical diffraction grating may be optically coupled between the detector(s) and the coupler.

In any one or more of the embodiments described above, the detector(s) may include a plurality of detectors, and each of the plurality of detectors may be optically coupled to the optical diffraction grating and linked to the controller.

In any one or more of the embodiments described above, the phosphor(s) may be optically coupled to a plurality of filters and each filter may be separately optically coupled to a detector. Each detector may be linked to the controller.

### BRIEF DESCRIPTION OF THE DRAWINGS

FIG. 1 is a sectional view of a disclosed gas turbine engine illustrating various points or stations where the disclosed temperature sensors may be employed.

FIG. 2 is a schematic illustration of a disclosed temperature sensor.

FIG. 3 graphically illustrates the relationship between fluorescent emission lifetime and temperature.

FIG. 4 is a schematic illustration of yet another disclosed temperature sensor.

FIG. 5 is a schematic illustration of yet another disclosed temperature sensor.

FIG. 6 is a schematic illustration of yet another disclosed temperature sensor.

FIG. 7 is a schematic illustration of yet another disclosed temperature sensor.

### DESCRIPTION

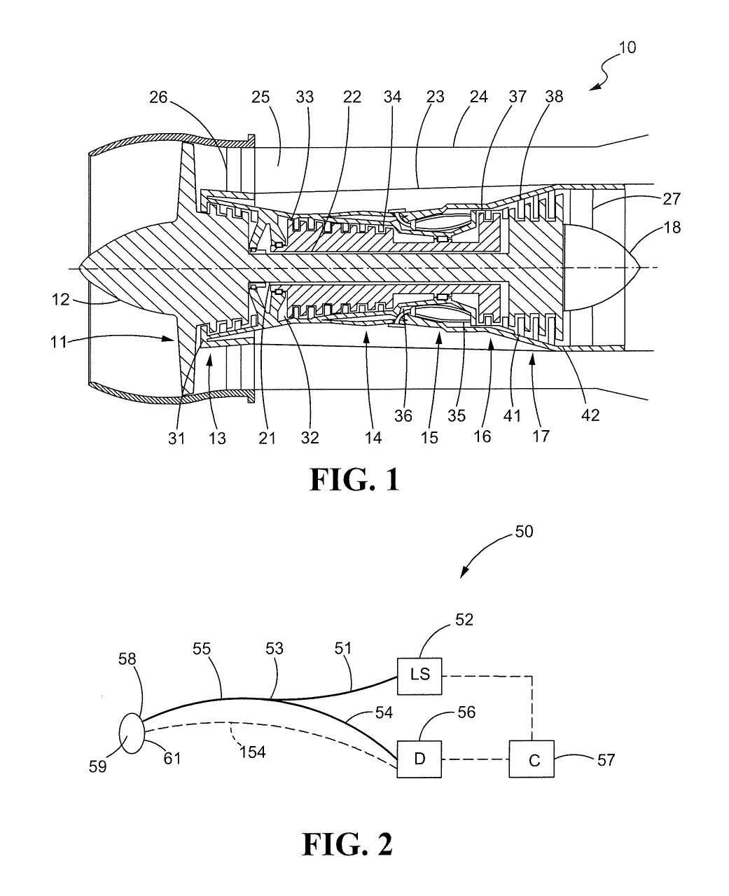

The most important parameter of the engine 10 to be monitored is temperature. In the operation of a dual shaft gas turbine engine 10, shown schematically in FIG. 1, air enters the LPC inlet 31 and is compressed until the air exits the LPC exit 32 thereby resulting in an increase in the air temperature and pressure. Air is then compressed as is passes from the HPC inlet 33 to the HPC exit 34 thereby resulting in another increase in air temperature and pressure. In the combustor 15, compressed air is mixed with fuel and combustion takes place. The combustion gases exit the combustor outlet 35 at higher temperature than at the combustor inlet 36 and with almost the same pressure. The combustion gases are expanded in the HPT 16 from the HPT inlet 37 to the HPT outlet 38 resulting in a reduction in pressure and temperature. The combustion gases are further expanded in the LPT 17 from its inlet 41 to its outlet 42 with another reduction in pressure and temperature. The gases are then released to the atmosphere past the nozzle 18. The following “stations” are commonly instrumented with thermocouples: LPC inlet 31; LPC outlet 32 or HPC inlet 33; HPC outlet 34 or combustor inlet 36; combustor outlet 35 or HPT inlet 37; HPT outlet 38 or LPT inlet 41; and the LPT outlet 42.

FIG. 2 schematically illustrates a sensor 50 that may be employed at any of the stations described above. The sensor 50 includes a first optical fiber 51 that couples a light source 52 to a coupler 53. The light source 52 may be a UV light source or may emit light of wave lengths that fall outside of the ultra violet range. Selection of the light source 52 will depend upon selection of the one or more phosphors 59. The coupler 53 connects the first optical fiber 51 to a second optical fiber 54 and a third optical fiber 55. The second optical fiber 54 couples the coupler 53 to a detector 56, which, as shown in FIG. 2 may be linked to a controller or microprocessor 57. The controller or microprocessor 57 may also be linked to the light source 52. The third optical fiber 55 couples the coupler 53 to a sensing end 58 of the third optical fiber 55, which may be coated with one or more phosphors 59. The phosphor(s) 59 and sensing end 58 may also be coated with an opaque material shown schematically at 61. The coupler 53 can be eliminated if a second optical fiber 154 is used that directly coupled the phosphor(s) 59 to the detector 56 as shown in FIG. 2.

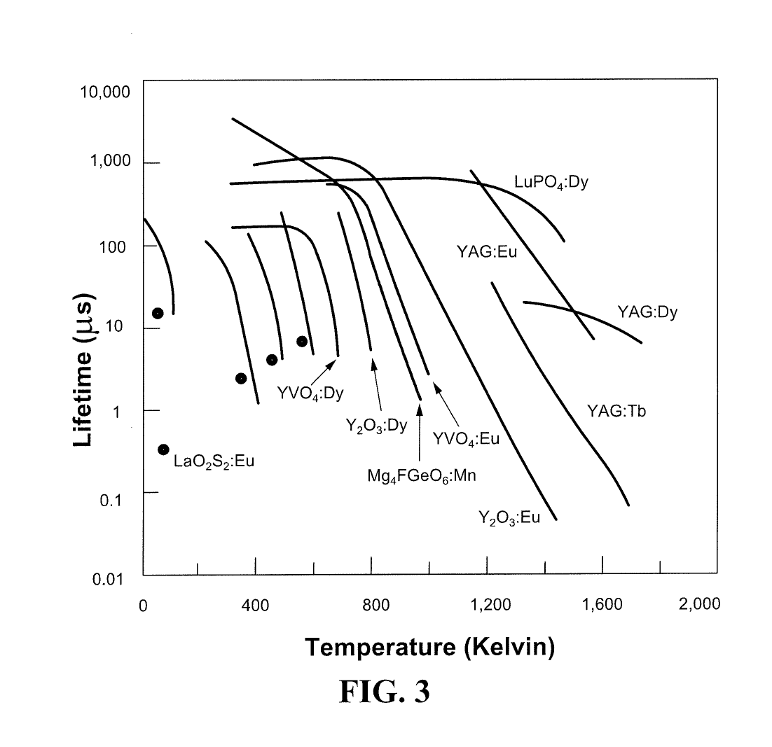

Turning to FIG. 3, the selection of the particular phosphor 59 will depend upon the anticipated temperature range. For example, Y₂O₃:Dy is suitable for a narrow temperature range just below 800° K. However, Y₂O₃:EU is effective, or provides a straight line slope from about 800° K through about 1400° K. YAG:Eu and YAG:Tb are suitable for narrower, but higher temperature ranges than Y₂O₃:Eu. While LaO₂S₂:Eu has series of emission peaks at different optical wavelengths enabling temperature measurements below 600° K. In another aspect, combinations of phosphors 59 may be employed to extend the usable temperature range of the disclosed sensors 50, 70, 80, 90 and 100.

Returning to FIG. 2, the coupler 53 is utilized so that at least some of the fluorescent emission from the phosphor(s) 59 passing through the third optical fiber 55 reaches the second optical fiber 54 and the detector 56. In one aspect, the splitting ratio of the coupler 53 could be set as function of wave length allowing most of the fluorescent emission to travel through the second optical fiber 54 to the detector 56, given the fact that excitation wave lengths, such as that produced by the light source 52, and emission wave lengths, such as that produced by the phosphor(s) 59, are relatively far apart. Further, a precise amplitude signal is not required at the detector 56 because the fluorescent emission decay time or lifetime will be constant for a given temperature, as shown in FIG. 3, and will therefore be insensitive to amplitude.

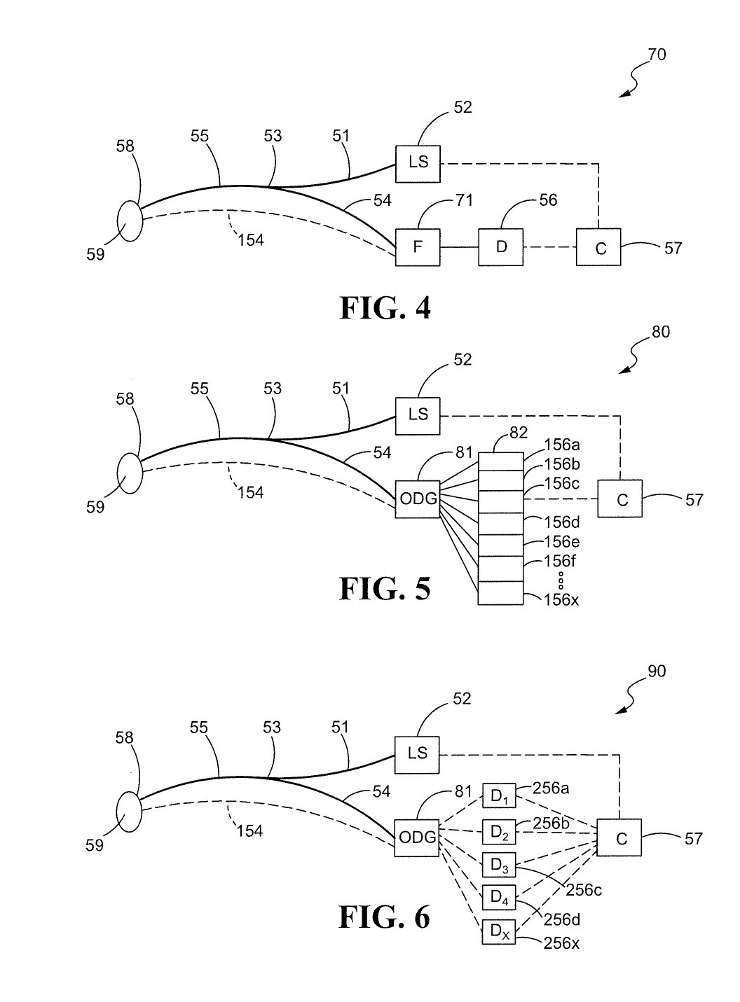

Turning to FIG. 4, another temperature sensor 70 is disclosed that also includes a light source 52 linked to a controller 57 that is also linked to a detector 56. The light source 52 emits light through the first optical fiber 51, through the coupler 53 and through the third optical fiber 55 before it engages the one or more phosphors 59 disposed at the sensing end 58 of the third optical fiber 55. A fluorescent emission from the phosphor(s) 59 travels back through the third optical fiber 55, through the coupler 53 and through the second optical fiber 54 to a filter 71. Of course, an optical fiber 154 may be used to directly couple the phosphor(s) 59 to the filter 71 (or detector 56) as opposed to coupling the phosphor(s) 59 to the filter 71 via the fibers 55, 54 and coupler 53. The filter 71 may be a band pass filter and may transmit a single narrow wave length band to the detector 56.

As noted above, the emission of a phosphor may include several discrete narrow wavelength bands or spectral lines. These spectral lines can vary in amplitude relative to each other as a function of temperature. Many phosphors emit groups or families of spectral lines where only one line is dominant over a range of temperature. As the temperature moves beyond this range, the next spectral line dominates the emission of excitation energy. Between temperature ranges, an overlap region may occur where both spectral lines are present and the relative amplitude each spectral line changes as a function of temperature which may be used to improve temperature measurement accuracy. While the temperature sensors 50, 70 of FIGS. 2 and 4 respectively may be limited to detection of a single spectral line, the temperature sensors 80, 90 and 100 of FIGS. 5-7 respectively can detect a plurality of individual spectral emission lines as well as the lifetimes and relative amplitudes, which can be used to improve temperature measurement accuracy. As noted above, a plurality of phosphors may be employed to expand the temperature range of the resulting sensors 50, 70, 80, 90 and 100.

Specifically, referring to FIG. 5, the temperature sensor 80 also includes a light source 52, a first optical fiber 51, a coupler 53, and a second optical fiber 54, and a third optical fiber 55. The sensing end 58 of the third optical fiber 55 is coated with one or more phosphors 59. Instead of the coupler 53 and second optical fiber 54, a second optical fiber 154 may be used to directly couple the phosphor(s) 59 to an optical diffraction grating 81. Otherwise, the phosphor(s) 59 may be coupled to the optical grating by the fibers 55 and 54. The optical diffraction grating, as described above, splits and diffracts the fluorescent emission from the phosphor 59 into several different beams traveling in different directions. The optical diffraction grating is optically coupled to a linear detector array 82 which may include a sufficient number of detectors or photodiodes shown schematically at 156a-156x. The linear detector array 82 is linked to the controller 57 which has a memory that may be programmed to compare the relative amplitudes of the spectral lines as well as the lifetimes for purposes of increasing the accuracy of the temperature measurement.

Turning to FIG. 6, another temperature sensor 90 is disclosed which also includes a light source 52 that is linked to a controller 57. The light source 52 is also coupled to one or more phosphors 59 by way of a first optical fiber 51 that may be connected to a coupler 53 which, in turn, is connected to a third optical fiber 55 that includes a sensing end 58 that is coated with the phosphor(s) 59. Alternatively, for both the sensors 80, 90, the light sources 52 may be directly optically coupled to the phosphor(s) 59 by a single optical fiber 51, thereby eliminating the coupler. In FIG. 6, the second and third optical fibers 54, 55 and the coupler 53 to the optical diffraction grating 81. Alternatively, the second optical fiber 154 may directly couple the phosphor(s) 59 to the optical diffraction grating 81. The optical diffraction grating 81, as opposed to being coupled to a linear array 82 as shown in FIG. 5, may be coupled to a plurality of discrete detectors 256a-256x. The plurality of discrete detectors 256a-256x may then be linked to the controller 57.

This configuration may also include a cascade of couplers or a 1 by N coupler to run a single fiber to the phosphor that collected the light. The multiplicity of outputs would go through the filters as shown.

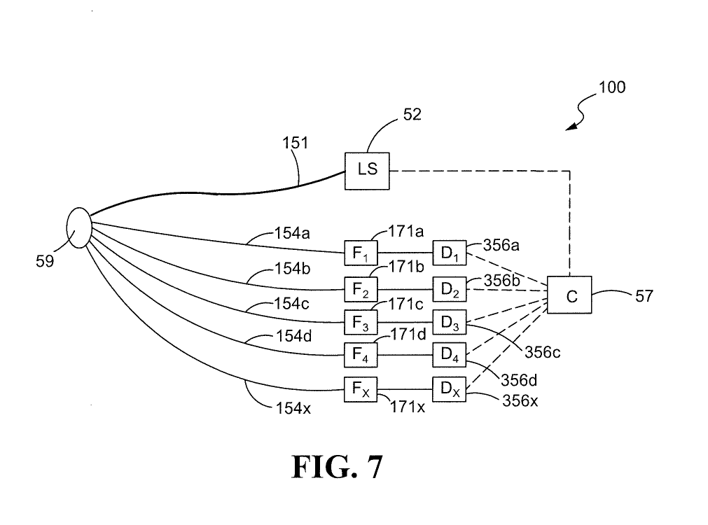

Finally, turning to FIG. 7, yet another temperature sensor 100 is disclosed that also includes a light source 52 linked to a controller 57 as well as a phosphor(s) 59 by way of a single optical fiber 151. Individual second optical fibers 154a-154x may be employed to optically couple the phosphor(s) 59 to a plurality of discrete band pass filters 171a-171x as shown in FIG. 7. Each filter 171a-171x may be optically coupled to a detector 356a-356x. Each of the detectors 356a-356x may then be linked to the controller where the lifetimes and relative amplitudes of the detected emission lines can be measured and compared for a more accurate temperature reading.

As shown in FIG. 3, the various phosphors illustrated correlate fluorescent emission lifetime to temperature with a relatively high precision. Thus, accurate temperature measurements can be made at the compressors 13, 14, turbines 16, 17, or combustor 15 and these temperature measurements could be used to monitor and improve the operational characteristics of the fan 11, the compressors 13, 14, the turbines 16, 17 and the compressor 15. Monitoring the temperatures can also be used to monitor high temperature components and their temperature limits and assist with maintenance by recording temperature histories of selected parts. Further, the temperature measurements do not require knowledge of the absolute temperature. Specifically, two probes utilized that include the same phosphor or same batch of phosphor will have identical temperature-time constant calibration curves as shown in FIG. 3. Thus, the results of both measurements will share the same systematic errors, which will cancel out when calculating a temperature rise or a temperature decrease.

The disclosed use of optical fibers 51, 54, 55, 154 and 154a-154x can be a direct replacement for conventional thermocouples, which are still in use. The light source 52 can be a solid state UV light source and the temperature sensors could be confined within a small space thereby eliminating the need for technicians to have to work with long optical fibers. Further, adding electronics, such as a microprocessor 57, could permit the creation of a networked probe architecture where data will travel on a single cable as a serial stream from the probes.

1. A temperature sensor comprising:
a light source optically coupled to at least one phosphor, the light source emitting an excitation light onto the at least one phosphor, the at least one phosphor producing at least one fluorescent emission when engaged by the excitation light;
the at least one phosphor being optically coupled to a detector; and
the detector being linked to a controller having a memory programmed to calculate temperature from at least one lifetime of the at least one fluorescent emission.

2. The temperature sensor of claim 1 wherein the at least one phosphor is optically coupled to the light source by at least one optical fiber, and wherein the at least one phosphor and at least one optical fiber are coated with an opaque material.

3. The temperature sensor of claim 1 wherein the light source is an ultra-violet light source.

4. The temperature sensor of claim 1 wherein the detector is a photo detector.

5. The temperature sensor of claim 1 wherein the light source is optically coupled to a first optical fiber;
the first optical fiber being connected to a second optical fiber and a third optical fiber at a coupler;
the second optical fiber connecting the coupler to a detector;
the third optical fiber connecting the coupler to a sensing end of the third optical fiber that is coated with the at least one phosphor; and
the third optical fiber transmitting at least one fluorescent emission from the at least one phosphor to the coupler which transmits at least some of the at least one fluorescent emission to the second optical fiber and the detector.

6. The temperature sensor of claim 5 wherein the sensing end of the third optical fiber and the at least one phosphor are coated with an opaque material.

7. The temperature sensor of claim 1 further comprising a filter optically coupled between the detector and the at least one phosphor.

8. The temperature sensor of claim 5 further comprising a filter optically coupled between the detector and the coupler.

9. The temperature sensor of claim 5 further comprising a filter optically coupled to the second optical fiber between the detector and the coupler.

10. The temperature sensor of claim 1 further comprising an optical diffraction grating optically coupled between the detector and the at least one phosphor.

11. The temperature sensor of claim 10 wherein the detector is a detector array.

12. The temperature sensor of claim 5 further comprising an optical diffraction grating optically coupled between the detector and the coupler.

13. The temperature sensor of claim 5 further comprising an optical diffraction grating optically coupled to the second optical fiber and between the detector and the coupler.

14. The temperature sensor of claim 13 wherein the detector is a linear detector array.

15. The temperature sensor of claim 13 wherein the detector includes a plurality of detectors, each of the plurality of detectors is optically coupled to the optical diffraction grating and linked the controller.

16. The temperature sensor of claim 1 wherein the phosphor is optically coupled to a plurality of filters, each filter being optically coupled to a detector, each detector being linked to the controller.

17. A gas turbine engine comprising:
a plurality of temperature sensors, at least one of the temperature sensors including
a light source optically coupled to at least one phosphor, the light source emitting an excitation light onto the at least one phosphor, the at least one phosphor producing at least one fluorescent emission when engaged by the excitation light;
the at least one phosphor being optically coupled to at least one filter;
the at least one filter being optically coupled to a detector;
the detector being linked to a controller, the controller also linked to the light source, the controller having a memory programmed to calculate temperature from at least one lifetime of the at least one fluorescent emission.

18. A gas turbine engine comprising:
at least two like temperature sensors including, each temperature sensor including
a light source optically coupled to at least one phosphor for generating at least one fluorescent emission and an optical diffraction grating for receiving the at least one fluorescent emission, the optical diffraction grating being optically coupled to a plurality of detectors, each of the plurality of detectors being linked to a controller, the controller being linked to the respective light source;
the controller having a memory programmed to calculate temperatures from at least one lifetime of the at least one fluorescent emissions for both sensors; and
the memory of the controller also programmed to adjust the calculated temperatures to account for systematic errors common to both sensors.

19. The gas turbine engine of claim 18 wherein the plurality of detectors is a linear detector array.
